(19) United States
(12) Patent Application Publication
(10) Pub. No.: US 2016/0285256 A1
(43) Pub. Date: Sep. 29, 2016

(54) INTEGRATED CIRCUIT AND IMPLEMENTATION METHOD THEREOF

(71) Applicants: Jeng-Huang Wu, Hsinchu County (TW); Tang-Long Chang, Hsinchu (TW); Wang-Chin Chen, Kaohsiung City (TW)

(72) Inventors: Jeng-Huang Wu, Hsinchu County (TW); Tang-Long Chang, Hsinchu (TW); Wang-Chin Chen, Kaohsiung City (TW)

(73) Assignee: Faraday Technology Corp., Hsinchu (TW)

(21) Appl. No.: 14/712,907

(22) Filed: May 14, 2015

(30) Foreign Application Priority Data
Mar. 26, 2015 (TW) 104109728

(51) Int. Cl. H02H 9/04

(52) U.S. Cl. CPC H02H 9/04

(57) ABSTRACT

An integrated circuit (IC) including a unit area, a first input/output (IO) cell, a second IO cell, an electrostatic discharge (ESD) component, a first IO pad and a second IO pad is provided. The unit area is divided into several subareas, wherein a subarea of an i^{th} column and a j^{th} row of those subareas is defined as SA_{(i,j)}. The first IO cell is arranged in subareas SA_{(i,j)} and SA_{(i,j+1)} of those subareas. The second IO cell is arranged in a subarea SA_{(i+1,j+1)} of those subareas. The ESD component is arranged in at lease one of the subareas of the j^{th} row. The first IO pad is arranged on the first IO cell, and electrically connected to the first IO cell. The second IO pad is arranged on the second IO cell, and electrically connected to the second IO cell.

### CROSS-REFERENCE TO RELATED APPLICATION

This application claims the priority benefit of Taiwan application serial no. 104109728, filed on Mar. 26, 2015. The entirety of the above-mentioned patent application is hereby incorporated by reference herein and made a part of this specification.

### BACKGROUND OF THE INVENTION

1. Field of the Invention

The invention relates to an electronic circuit, and particularly relates to an integrated circuit and an implementation method thereof.

2. Description of Related Art

Integrated circuits (ICs) play an important part in development of modern science and technology. The ICs are widely used in daily life, for example, the ICs are used in micro controller units (MCUs), mobile phone chips and even memory chips. As electronic devices are developed towards a trend of multifunction and precision, sizes and layout areas of the ICs become a study and research objective of various manufacturers.

### SUMMARY OF THE INVENTION

The invention is directed to an integrated circuit (IC) and an implementation method thereof, where an area of the IC is reduced by changing a layout method of input/output cells, an electrostatic discharge component and input/output pads.

The invention provides an integrated circuit including a unit area, a first input/output (IO) cell, a second IO cell, an electrostatic discharge (ESD) component, a first IO pad and a second IO pad. The unit area is divided into a plurality of subareas, where a subarea of an i^{th} column and a j^{th} row in the subareas is defined as SA_{(i,j)}, and i and j are integers. The first IO cell is arranged in a subarea SA_{(i,j+1)} of the subareas. The second IO cell is arranged in a subarea SA_{(i+1,j+1)} of the subareas. The ESD component is arranged in at least one of the subareas of the j^{th} row. The first IO pad is arranged on the first IO cell and electrically connected to the first IO cell. The second IO pad is arranged on the second IO cell and electrically connected to the second IO cell.

The invention provides an implementation method of an integrated circuit, which includes following steps. A unit area is divided into a plurality of subareas, where a subarea of an i^{th} column and a j^{th} row in the subareas is defined as SA_{(i,j)}, and i and j are integers. A first IO cell is arranged in a subarea SA_{(i,j+1)} of the subareas. A second IO cell is arranged in a subarea SA_{(i+1,j+1)} of the subareas. An ESD component is arranged in at lease one of the subareas of the j^{th} row. A first IO pad is arranged on the first IO cell and electrically connected to the first IO cell. A second IO pad is arranged on the second IO cell and electrically connected to the second IO cell.

According to the above descriptions, the IO cells, the ESD component and the IO pads are effectively configured to decrease a layout area of the IC, so as to reduce a size of the IC. In some embodiments, one of the IO cells is selectively set as a power/ground IO cell, and the ESD component is coupled to the power/ground IO cell to protect the IC from being damaged by ESD. Moreover, as the power/ground IO cell has a metal layer and does not have any electronic component, an influence of IR drop of the power supply on the IC is mitigated.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A, FIG. 1B and FIG. 1C are schematic diagrams illustrating different layout patterns of an integrated circuit (IC) 100A according to an embodiment of the invention.

FIG. 2A and FIG. 2B are schematic diagrams illustrating different configuration patterns of a first input/output (IO) cell.

FIG. 3A and FIG. 3B are schematic diagrams illustrating different layout patterns of an IC according to another embodiment of the invention.

FIG. 4A, FIG. 4B and FIG. 4C are schematic diagrams illustrating different configuration patterns of an IO cell.

FIG. 5A and FIG. 5B are schematic diagrams illustrating different layout patters of an IC according to still another embodiment of the invention.

FIG. 6 is a flowchart illustrating an implementation method of an IC according to an embodiment of the invention.

### DESCRIPTION OF EMBODIMENTS

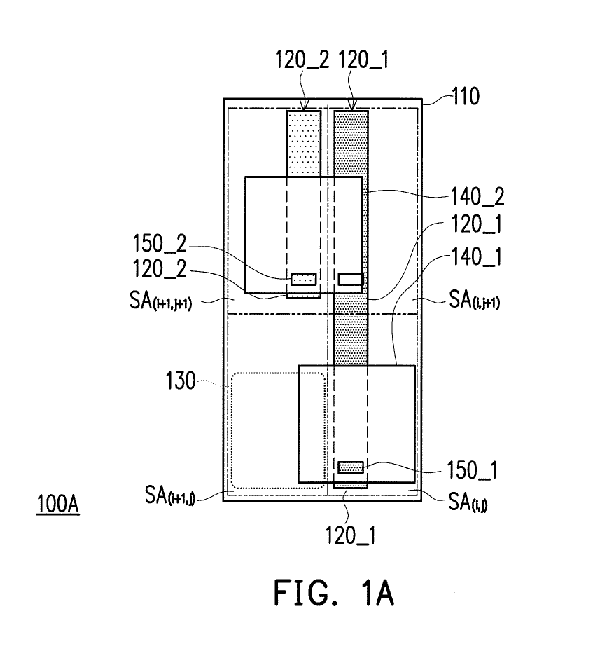

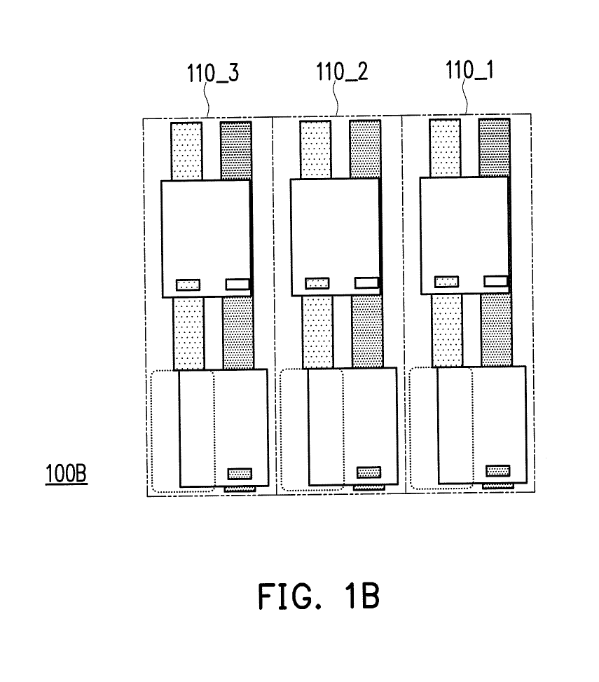

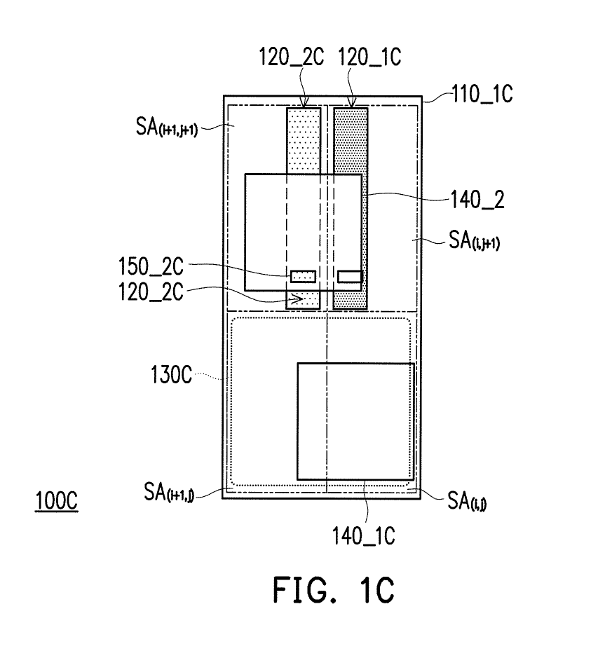

FIG. 1A is a layout schematic diagram of an integrated circuit (IC) 100A according to an embodiment of the invention. Referring to FIG. 1A, the IC 100A includes a unit area 110, a first input/output (IO) cell 120_1, a second IO cell 120_2, an electrostatic discharge (ESD) component 130, a first IO pad 140_1 and a second IO pad 140_2. The unit area 110 can be divided into a plurality of subareas. In the present embodiment, a subarea of an i^{th} column and a j^{th} row is defined as SA_{(i,j)}, where i and j are integers, and the other subareas are deduced by analogy. As shown in FIG. 1, the unit area 110 of the present embodiment is divided into a subarea SA_{(i,j)}, a subarea SA_{(i,j+1)}, a subarea SA_{(i+1,j)} and a subarea SA_{(i+1,j+1)}. The first IO cell 120_1 is arranged in the subarea SA_{(i,j)} and the subarea SA_{(i,j+1)}. The second IO cell 120_2 is arranged in the subarea SA_{(i+1,j+1)}. In the present embodiment, the ESD component 130 arranged in the subarea SA_{(i+1,j)} of the subareas of the j^{th} row. The first IO pad 140_1 is arranged (stacked) on the first IO cell 120_1 and is electrically connected to the first IO cell 120_1 through a via plug 150_1. The second IO pad 140_2 is arranged (stacked) on the second IO cell 120_2 and is electrically connected to the second IO cell 120_2 through a via plug 150_2.

According to the above design, by covering the first IO pad 140_1 on the first IO cell 120_1, and covering the second IO pad 140_2 on the second IO cell 120_2, a layout area of the IC 100A is decreased, so as to decrease a size area of the IC 100A.

Moreover, in the present embodiment, the first IO pad 140_1 further partially covers the ESD component 130, and/or the second IO pad 140_2 further partially covers the first IO cell 120_1.

In the present embodiment, the IO cell of the IC 100A can be a power/ground IO cell or a signal IO cell. In other words, one of the first IO cell 120_1 and the second IO cell 120_2 can be the power/ground IO cell, for example, the power/ground IO cell of the present embodiment is the first IO cell 120_1. However, in other embodiments, the power/ground IO cell can also be the second IO cell 120_2. In view of the operation of the IC 100A, the power/ground IO cell can serve as a power supply interface. An external power supplier (not shown) of the IC 100A can supply power to a core circuit (not shown) of the IC 100A through the power/ground IO cell, and/or supply power to the other IO cells of the IC 100A through the power/ground IO cell.

The power/ground IO cell of the present embodiment may have a metal layer, and none electronic component (for example, passive components such as capacitors, etc., and/or active components such as transistors, etc.) is configured thereon. The metal layer without electronic component can reduce an influence of an IR drop of a power supply on the IC. The ESD component 130 is electrically connected to the power/ground IO cell (for example). In the present embodiment, the power/ground IO cell is the first IO cell 120_1. Since the ESD component 130 is located adjacent to the first IO cell 120_1, when the IC 100A has an ESD event, the ESD component 130 can opportunely guide an ESD current to the first IO cell 120_1, or opportunely guide the ESD current of the first IO cell 120_1 to the other power/ground IO cell (not shown), so as to prevent the ESD current from causing damage to the IC 100A. Implementation and operation of the ESD component 130 may adopt a conventional ESD technique or other ESD protection techniques, which are not repeated.

Moreover, in the present embodiment, the number of the unit areas 110 of the IC 100A can be plural and the unit areas 110 can be arranged adjacent to each other, as that shown in FIG. 1B. FIG. 1B is a layout schematic diagram of an IC 100B according to another embodiment of the invention. The unit areas 110_1, 110_2 and 110_3 included in the IC 100B are arranged adjacent to each other, and in the present embodiment, the number of the unit areas is not limited by the invention, which can be modified by those skilled in the art according to an actual requirement. Implementation details of the unit areas 110_1, 110_2 and 110_3 can be deduced by referring to related description of the unit area 110 of FIG. 1A, which are not repeated.

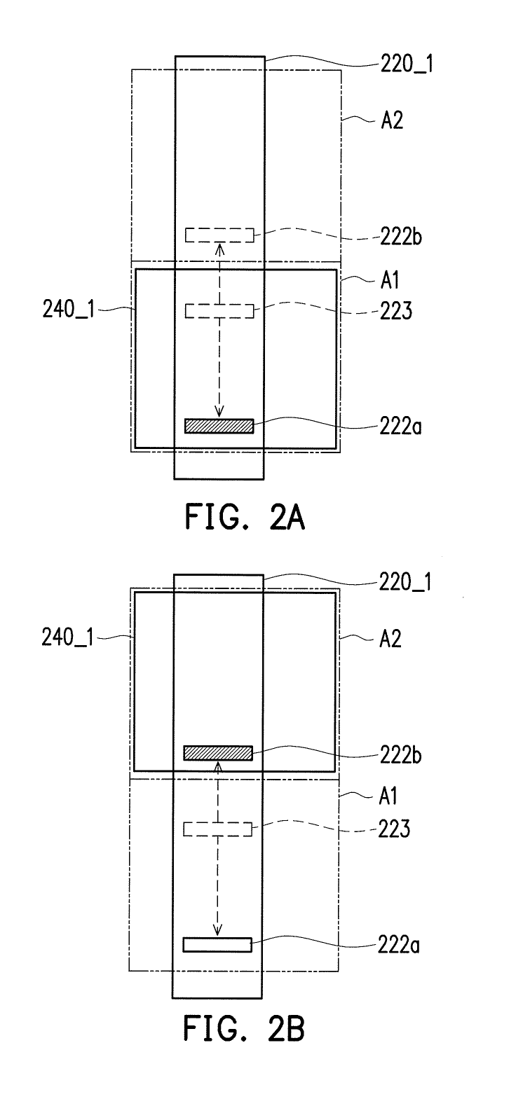

It should be noticed that since the ESD component of the invention can be arranged in at least one of the subareas of the j^{th} row, the ESD component is not limited to be arranged in the subarea SA_{(i+1,j)} of the aforementioned embodiment, as that shown in FIG. 1C, FIG. 1C is a layout schematic diagram of an IC 100C according to still another embodiment of the invention. The IC 100C includes a first IO cell 120_1C, a second IO cell 120_2C, an ESD component 130C, a first IO pad 140_1C and a second IO pad 140_2C. Different to the ESD component 130 of the embodiment of FIG. 1B, the ESD component 130C of the present embodiment is arranged in the subarea SA_{(i,j)} and the subarea SA_{(i+1,j)}. The first IO cell 120_1C is correspondingly adjusted to be arranged in the subarea SA_{(i,j+1)}. In other words, the ESD component of the invention can be arranged in at least on subarea of the j^{th} row, for example, in the subarea SA_{(i+1,j)} of the embodiment of FIG. 1A, and in the subarea SA_{(i,j)} and the subarea SA_{(i+1,j)} of the embodiment of FIG. 2B. Therefore, in other embodiments, the ESD component can also be arranged in the subarea SA_{(i,j)}, and the second IO cell is correspondingly adjusted to be arranged in the subarea SA_{(i+1,j)} and the subarea SA_{(i+1,j+1)}.

FIG. 2A and FIG. 2B are schematic diagrams illustrating different configuration patterns of a first IO cell 220_1 according to different embodiments of the invention, and the first IO cell 220_1 is also adapted to the embodiment of FIG. 1A or FIG. 1B. In the present embodiment, the first IO cell 220_1 can be deduced according to related description of the first IO cell 120_1 of FIG. 1A. The first IO cell 120_1 and/or the second IO cell 120_2 of FIG. 1A can also be deduced according to related description of the first IO cell 220_1 of FIG. 2A or FIG. 2B.

Referring to FIG. 2A, the first IO cell 220_1 includes an active region, where the active region is used for accommodating a circuit layout of the first IO cell 220_1. The active region of the first IO cell 220_1 is configured with a plurality of IO ports, for example, an IO port 222a and an IO port 222b shown in FIG. 2A. The IO port 222a and the IO port 222b can transmit a same signal of a same IO pin 223 in the first IO cell 220_1. The IO port 222a and the IO port 222b can respectively provide a corresponding predetermined area A1 and a predetermined area A2. The predetermined area A1 and the predetermined area A2 can respectively accommodate one IO pad.

It should be noticed that the first IO cell 220_1 may have a plurality of different configurations based on the IO ports 222a and 222b, and in each of the configurations, the predetermined area corresponding to at least one IO port is configured with the first IO pad 240_1, and the predetermined area corresponding to at least one other IO port is empty and is not configured with the IO pad. For example, in view of the configuration of the present embodiment, the predetermined area A1 corresponding to the IO port 222a is configured with the first IO pad 240_1, and the predetermined area A2 corresponding to the other IO port 222b is empty and is not configured with the IO pad. Therefore, the IO pin 223 can perform signal transmission with the first IO pad 240_1 through the IO port 222a.

Similarly, the first IO cell 220_1 in FIG. 2A may have a different implementation. Referring to FIG. 2B, FIG. 2B is a schematic diagrams of a configuration pattern of a first IO cell 220_1 according to another different embodiment of the invention. In the configuration of the presented embodiment, the predetermined area A2 corresponding to the IO port 222b is configured with the first IO pad 240_1, and the predetermined area A1 corresponding to the IO port 222a is empty and is not configured with the IO pad. Therefore, the IO pin 223 can perform signal transmission with the first IO pad 240_1 through the IO port 222b.

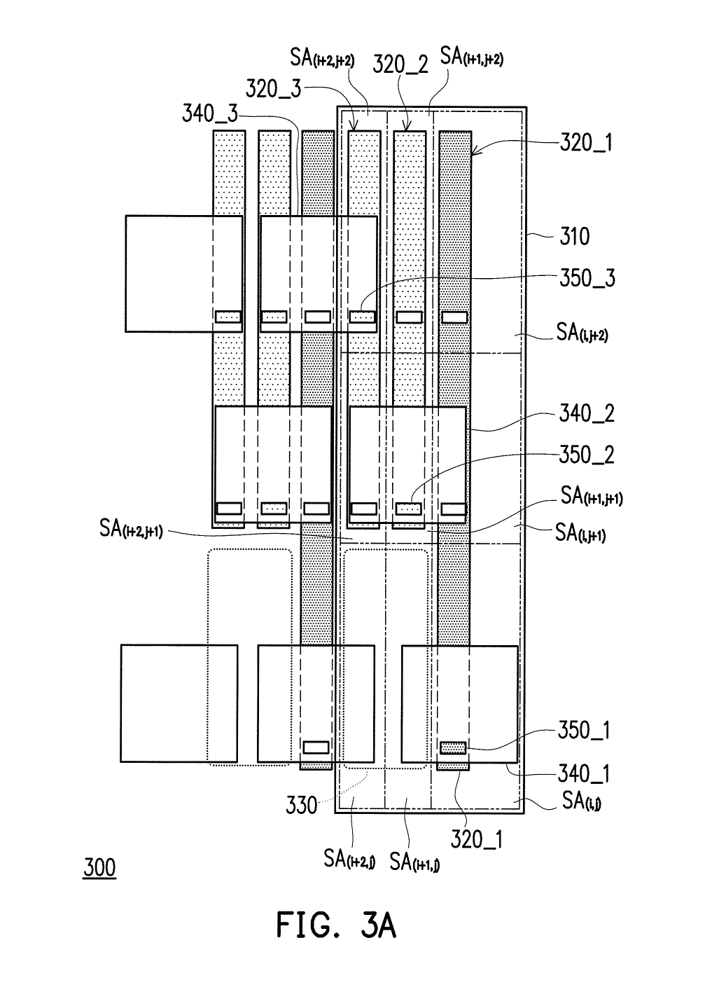

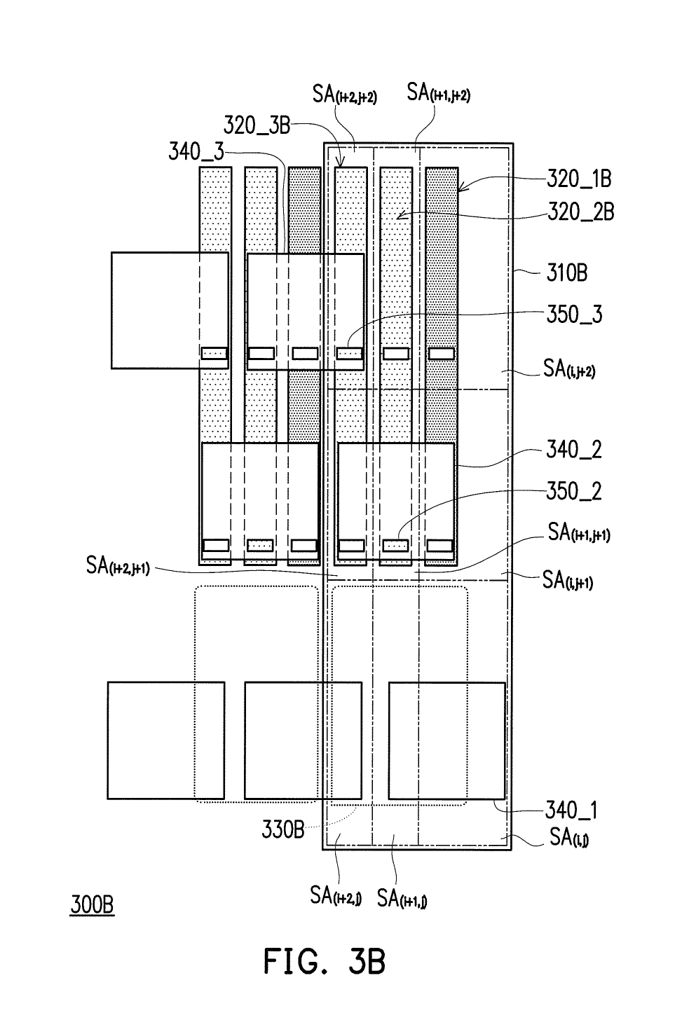

Referring to FIG. 3A and FIG. 3B, FIG. 3A and FIG. 3B are schematic diagrams illustrating different layout patterns of an IC according to an embodiment of the invention. A difference between the IC 300 of FIG. 3A and the IC 100 is that the unit area 110 of the IC 100 is divided into 4 subareas, while the unit area 310 of the IC 300 of the present embodiment is divided into 9 subareas including a subarea SA_{(i,j)}, a subarea SA_{(i,j+1)}, a subarea SA_{(i,j+2)}, a subarea SA_{(i+1,j)}, a subarea SA_{(i+1,j+1)}, a subarea SA_{(i+1,j+2)}, a subarea SA_{(i+2,j)}, a subarea SA_{(i+2,j+1)} and a subarea SA_{(i+2,j+2)}. The IC 300 includes a first IO cell 320_1, a second IO cell 320_2, a third IO cell 320_3, an ESD component 330, a first IO pad 340_1, a second IO pad 340_2 and a third IO pad 340_3. The first IO cell 320_1 is arranged in the subarea SA_{(i,j)}, the subarea SA_{(i,j+1)} and the subarea SA_{(i,j+2)}. The second IO cell 320_2 is arranged in the subarea SA_{(i+1,j+1)} and the subarea SA_{(i+1,j+2)}. The third IO cell 320_3 is arranged in the subarea SA_{(i+2,j+1)} and the subarea SA_{(i+2,j+2)}. The ESD component 330 is disposed in the subarea SA_{(i+1,j)} and the subarea SA_{(i+2,j)} of a j^{th} row.

The first IO pad 340_1 is arranged (stacked) on the first IO cell 320_1, and is electrically connected to the first IO cell 320_1 through a via plug 350_1. The second IO pad 3402 is arranged (stacked) on the second IO cell 320_2, and is electrically connected to the second IO cell 320_2 through a via plug 350_2. The third IO pad 340_3 is arranged (stacked) on the third IO cell 320_3, and is electrically connected to the third IO cell 320_3 through a via plug 350_3.

One of the first IO cell 320_1, the second IO cell 320_2 and the third IO cell 320_3 of the IC 300 of the present embodiment can be a power/ground IO cell. For example (but not limited thereto), the first IO cell 320_1 can be the power/ground IO cell, and the second IO cell 320_2 and the third IO cell 320_3 can be signal IO cells. However, in different embodiments, the power/ground IO cell can also be the second IO cell 320_2 or the third IO cell 320_3. The ESD component 330 is electrically connected to the power/ground IO cell (one of the IO cells 320_1, 320_2 and 320_3) to protect the IC 300 from ESD interference to ensure a normal operation thereof. Since the ESD component 330 is located adjacent to the power/ground IO cell (one of the IO cells 320_1, 320_2 and 320_3), when the IC 300 has an ESD event, the ESD component 330 can opportunely guide an ESD current to the power/ground IO cell (one of the IO cells 320_1, 320_2 and 320_3), or opportunely guide the ESD current of the power/ground IO cell (one of the IO cells 320_1, 320_2 and 320_3) to the other power/ground IO cell (for example, the power/ground IO cell in the neighbouring unit area), so as to avoid causing damage to the IC 300. Implementation and operation of the ESD component 330 may adopt a conventional ESD technique or other ESD protection techniques, which are not repeated.

One of the first IO cell 320_1, the second IO cell 320_2 and the third IO cell 320_3 of the IC 300 of the present embodiment can be a signal IO cell. The signal IO cell is electrically connected to a signal pin of a core circuit (not shown) of the IC 300. During the operation of the IC 300, the signal IO cell can serve as a signal (data) communication interface between the core circuit (not shown) and an external circuit of the IC 300.

The ESD component 330 of the present embodiment may also have different configurations. Referring to FIG. 3B, FIG. 3B is a schematic diagram of a layout pattern different the layout pattern of FIG. 3A. The components of the IC 300B may refer to the embodiment of FIG. 3A, and since the ESD component of the invention can be arranged in at least one subarea of the j^{th} row, in the present embodiment, the ESD component 330B is arranged in the subarea SA_{(i,j)}, the subarea SA_{(i+1,j)} and the subarea SA_{(i+2,j)}, and the first IO cell 320_1B is correspondingly adjusted to be arranged in the subarea SA_{(i,j+1)} and the subarea SA_{(i,j+2)}. Moreover, in a different embodiment, the ESD component can also be arranged in the subarea SA_{(i,j)}, and the second IO cell 320_2B is correspondingly adjusted to be arranged in the subarea SA_{(i+1,j+1)} and the subarea SA_{(i+1,j+2)}, and the third IO cell 320_3B is correspondingly adjusted to be arranged in the subarea SA_{(i+2,j+1)} and the subarea SA_{(i+2,j+2)}. Similarly, in other different embodiment, the ESD component can also be arranged in the subarea SA_{(i,j)} and the subarea SA_{(i+1,j)}, and detail thereof is not repeated.

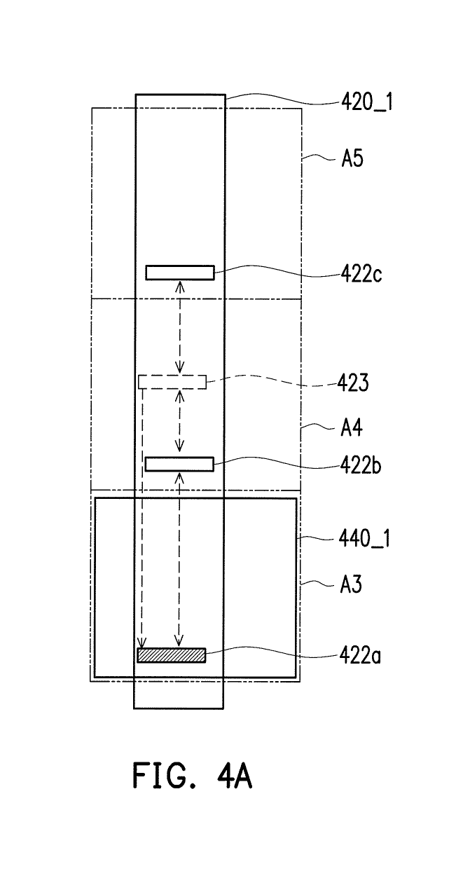

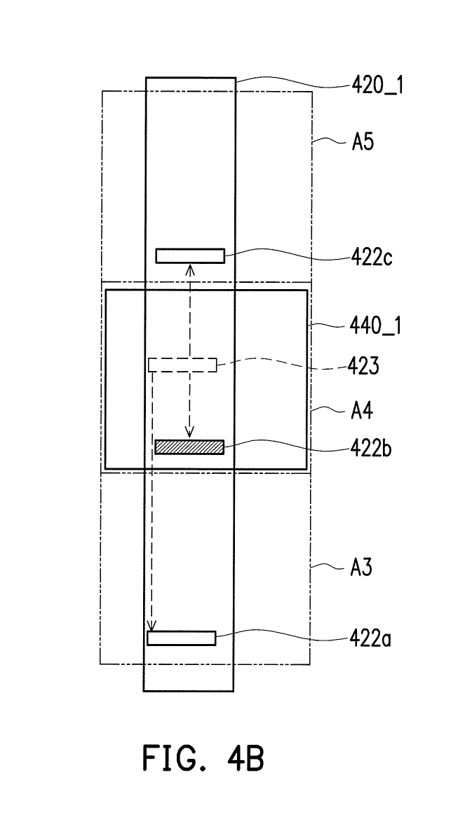

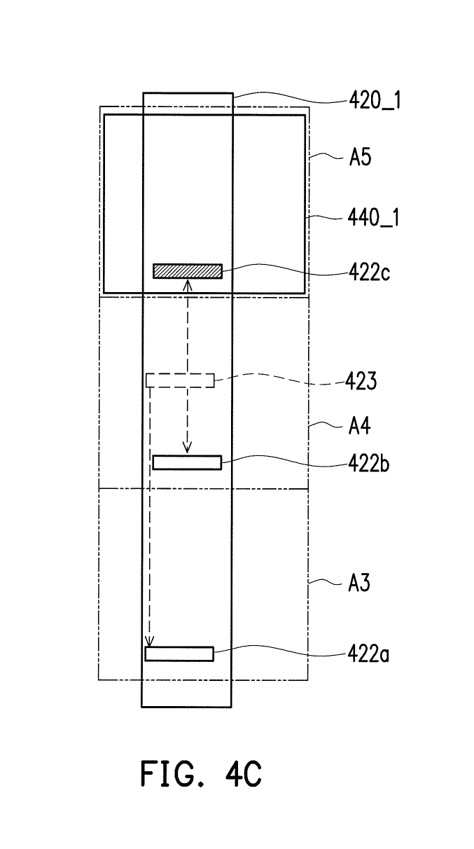

FIG. 4A, FIG. 4B and FIG. 4C are schematic diagrams illustrating different configuration patterns of an IO cell 420_1 (for example, a signal IO cell) according to different embodiments of the invention. The signal IO cell can be electrically connected to the signal pin of the core circuit (not shown) of the IC to serve as a signal transmission interface between the core circuit and the external circuit (not shown). The IO cell 420_1 of the present embodiment can be deduced according to related descriptions of the first IO cell 320_1, the second IO cell 320_2, or the third IO cell 320_3 shown in FIG. 3. The first IO cell 320_1, the second IO cell 320_2 and/or the third IO cell 320_3 shown in FIG. 3 can also be deduced according to related description of the IO cell 420_1 of FIG. 4A, FIG. 4B or FIG. 4C.

In the present embodiment, the IO cell 420_1 includes an active region. The active region is used for accommodating a circuit layout of the IO cell 420_1. The IO cell 420_1 further includes an IO port 422a, an IO port 422b and an IO port 422c. The IO ports (for example, the IO port 422a, the IO port 422b and the IO port 422c) can be arranged in the active region of the IO cell 420_1. The IO port 422a, the IO port 422b and the IO port 422c can transmit a same signal of a same IO pin 423 in the IO cell 420_1. Moreover, the IO port 422a, the IO port 422b and the IO port 422c respectively provide corresponding predetermined areas, for example, a predetermined area A3, a predetermined area A4 and a predetermined area A5 of the present embodiment, and each of the predetermined areas can accommodate one IO pad.

In the present embodiment, the IO ports can be designed according to different usage situations, such that the IO cell 420_1 may have different configurations. It should be noticed that in each of the configurations, the predetermined area corresponding to at least one IO port is configured with the IO pad, and the predetermined area corresponding to at least another IO port is empty and is not configured with the IO pad. For example, the predetermined area A3 in FIG. 4A is configured with the IO pad 440_1, and the predetermined area A4 and the predetermined area A5 are empty and are not configured with the IO pad.

Moreover, referring to FIG. 4B, FIG. 4B is a schematic diagram of illustrating a different configuration pattern of the IO cell 420_1 according to another embodiment of the invention. In the configuration of FIG. 4B, the predetermined area A4 is configured with the IO pad 440_1, and the predetermined area A3 and the predetermined area A5 are empty and are not configured with the IO pad. Referring to FIG. 4C, FIG. 4C is a schematic diagram of illustrating a different configuration pattern of the IO cell 420_1 according to still another embodiment of the invention. In the configuration of FIG. 4C, the predetermined area A5 is configured with the IO pad 440_1, and the predetermined area A3 and the predetermined area A4 are empty and are not configured with the IO pad. In brief, in the IO cell 420_1, one of the predetermined areas is configured with the IO pad and the other two predetermined areas are empty. It should be noticed that the related description of the IO cell 420_1 is adapted to the first IO cell 320_1, the second IO cell 320_2 or the third IO cell 320_3 in the IC 300.

Referring to FIG. 3 again, in the present embodiment, the first IO pad 340_1 partially covers the ESD component 330 and the first IO cell 320_1, and the second IO pad 340_2 partially covers the first IO cell 320_1, the second IO cell 320_2 and the third IO cell 320_2. The third IO pad 340_3 partially covers the third IO cell 320_2 and IO cells of the neighbouring unit area, as that shown in FIG. 3. According to such configuration, the layout area of the IC of the present embodiment can be decreased.

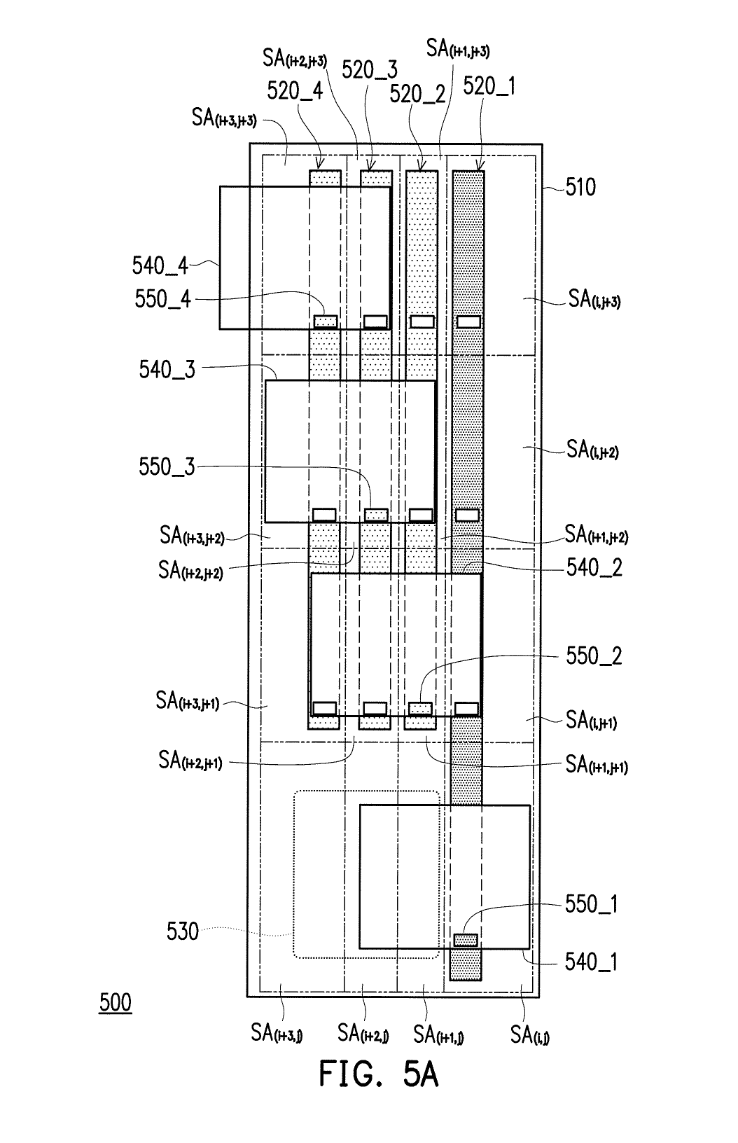

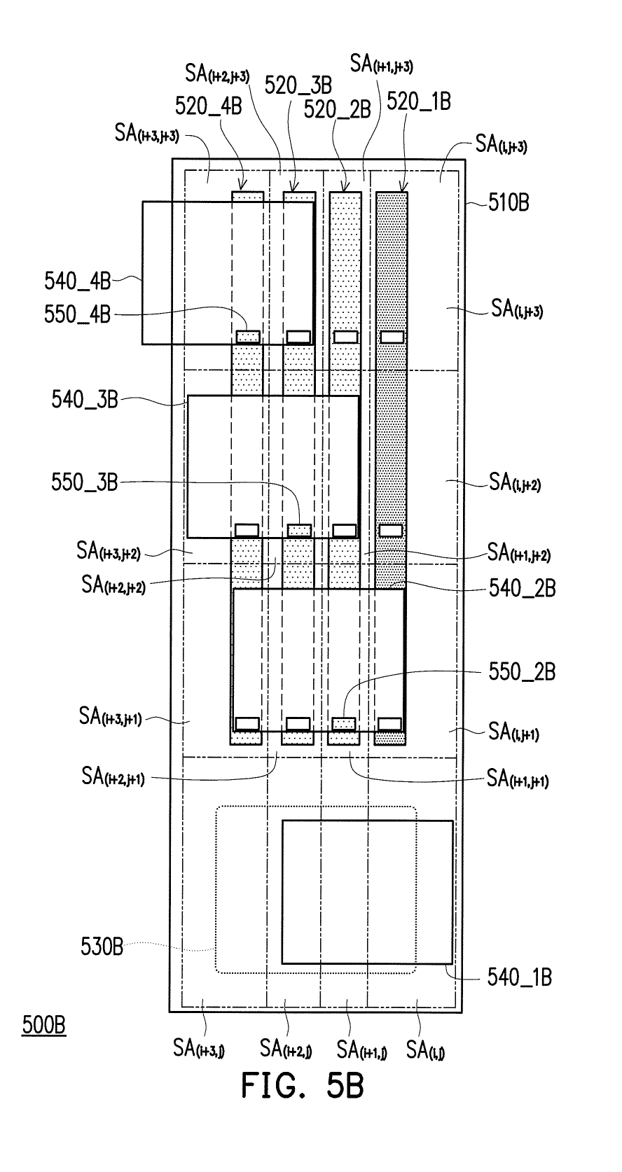

Proffering to FIG. 5A and FIG. 5B, FIG. 5A and FIG. 5B are schematic diagrams illustrating different layout patters of an IC according to an embodiment of the invention. In the embodiment of FIG. 5A, the unit area 510 of the IC 500 is divided into 16 subareas including a subarea SA_{(i,j)}, a subarea SA_{(i,j+1)}, a subarea SA_{(i,j+2)}, a subarea SA_{(i,j+3)}, a subarea SA_{(i+1,j)}, a subarea SA_{(i+1,j+1)}, a subarea SA_{(i+1,j+2)}, a subarea SA_{(i+1,j+3)}, a subarea SA_{(i+2,j)}, a subarea SA_{(i+2,j+1)}, a subarea SA_{(i+2,j+2)}, a subarea SA_{(i+2,j+3)}, a subarea SA_{(i+3,j)}, a subarea SA_{(i+3,j+1)}, a subarea SA_{(i+3,j+2)} and a subarea SA_{(i+3,j+3)}.

The IC 500 includes a first IO cell 520_1, a second IO cell 520_2, a third IO cell 520_3, a fourth IO cell 520_4, an ESD component 530, a first IO pad 540_1, a second IO pad 540_2, a third IO pad 540_3 and a fourth IO pad 540_4. The ESD component 530 is arranged in the subarea SA_{(i+1,j)}, the subarea SA_{(i+2,j)} and the subarea SA_{(i+3,j)} of the j^{th} row. The first IO cell 520_1 is arranged in the subarea SA_{(i,j)}, the subarea SA_{(i,j+1)}, the subarea SA_{(i,j+2)} and the subarea SA_{(i,j+3)}. The second IO cell 520_2 is arranged in the subarea SA_{(i+1,j+1)}, the subarea SA_{(i+1,j+2)} and the subarea SA_{(i+1,j+3)}. The third IO cell 520_3 is arranged in the subarea SA_{(i+2,j+1)}, the subarea SA_{(i+2,j+2)} and the subarea SA_{(i+2,j+3)}. The fourth IO cell 520_4 is arranged in the subarea SA_{(i+3,j+1)}, the subarea SA_{(i+3,j+2)} and the subarea SA_{(i+3,j+3)}.

The first IO pad 540_1 is arranged (stacked) on the first IO cell 520_1, and is electrically connected to the first IO cell 520_1 through a via plug 550_1. The second IO pad 540_2 is arranged (stacked) on the second IO cell 520_2, and is electrically connected to the second IO cell 520_2 through a via plug 550_2. The third IO pad 540_3 is arranged (stacked) on the third IO cell 520_3, and is electrically connected to the third IO cell 520_3 through a via plug 550_3. The fourth IO pad 540_4 is arranged (stacked) on the fourth IO cell 520_4, and is electrically connected to the fourth IO cell 520_4 through a via plug 550_4. Detailed operation of the IC 500 may refer to related description of the IC 100A, 100B or 300 of the aforementioned embodiment, which is not repeated.

Similar to the aforementioned embodiment of FIG. 3, the ESD component 530 in the embodiment of FIG. 5A may also have configuration of a different pattern. Referring to FIG. 5B, FIG. 5B illustrates a different layout pattern of FIG. 5A. The ESD component 530B of FIG. 5B is arranged in the subarea SA_{(i,j)}, the subarea SA_{(i+1,j)}, the subarea SA_{(i+2,j)} and the subarea SA_{(i+3,j)}, and the first IO cell 520_1B is accordingly adjusted to be arranged in the subarea SA_{(i,j+1)}, the subarea SA_{(i,j+2)} and the subarea SA_{(i,j+3)}. In other words, the ESD component of the present embodiment can be disposed in at least one subarea of the subareas of the j^{th} row, and other operation methods may refer to the aforementioned embodiment, which are not repeated.

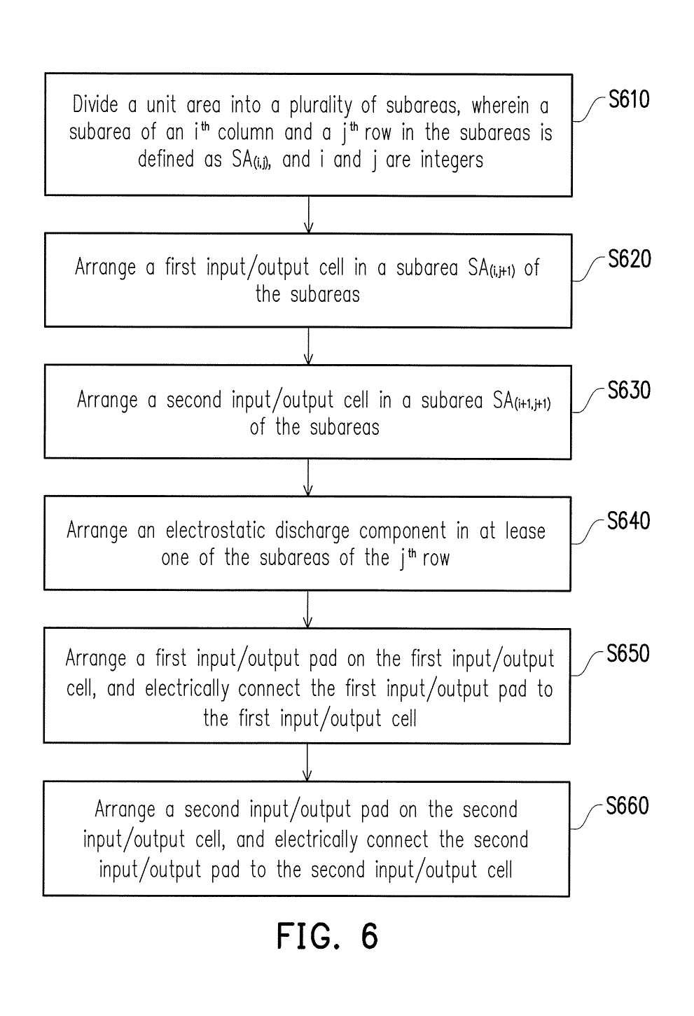

Referring to FIG. 6, FIG. 6 is a flowchart illustrating an implementation method of an IC according to an embodiment of the invention. The implementation method of the present embodiment is at least adapted to the IC 100A, 100B, 300 or 500 of the aforementioned embodiments. In step S610, a unit area is divided into a plurality of subareas, where a subarea of an i^{th} column and a j^{th} row in those subareas is defined as SA_{(i,j)}, and i and j are integers. In step S620, a first IO cell is arranged in a subarea SA_{(i,j)} and a subarea SA_{(i,j+1)} of those subareas. In step S630, a second IO cell is arranged in a subarea SA_{(i+1,j+1)} of those subareas. In step S640, an ESD component is arranged in at lease one of the subareas of the j^{th} row. In step S650, a first IO pad is arranged on the first IO cell and electrically connected to the first IO cell. In step S660, a second IO pad is arranged on the second IO cell and electrically connected to the second IO cell. The implementation method of the present embodiment can be referred with reference of the ICs of the aforementioned embodiments, which is not repeated.

In summary, the IO cells, the ESD component and the IO pads are effectively configured to decrease a layout area of the IC, so as to reduce a size of the IC. One of the IO cells is selectively set as a power/ground IO cell, and the ESD component is coupled to the power/ground IO cell to protect the IC from being damaged by ESD. Moreover, as the power/ground IO cell has a metal layer and does not have any electronic component, an influence of IR drop of the power supply on the IC is mitigated.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. An integrated circuit, comprising:
a unit area, divided into a plurality of subareas, wherein a subarea of an i^{th} column and a j^{th} row in the subareas is defined as SA_{(i,j)}, and i and j are integers;
a first input/output cell, arranged in a subarea SA_{(i,j+1)} of the subareas;
a second input/output cell, arranged in a subarea SA_{(i+1,j+1)} of the subareas;
an electrostatic discharge component, arranged in at least one of the subareas of the j^{th} row;
a first input/output pad, arranged on the first input/output cell and electrically connected to the first input/output cell; and
a second input/output pad, arranged on the second input/output cell and electrically connected to the second input/output cell.

2. The integrated circuit as claimed in claim 1, wherein one of the first input/output cell and the second input/output cell is a power/ground input/output cell, and the electrostatic discharge component is electrically connected to the power/ground input/output cell.

3. The integrated circuit as claimed in claim 2, wherein the power/ground input/output cell has a metal layer and does not have any electronic component.

4. The integrated circuit as claimed in claim 1, wherein the first input/output cell comprises:
an active region, configured to accommodate a circuit layout of the first input/output cell; and
a plurality of input/output ports, arranged in the active region, and configured to transmit a same signal of a same input/output pin, wherein each of the input/output ports provides a corresponding predetermined area, and each predetermined area accommodates the first input/output pad,
wherein the input/output ports make the first input/output cell to form a plurality of different configurations, and in each configuration, the predetermined area corresponding to at least one input/output port is configured with the first input/output pad, and the predetermined area corresponding to at least one other input/output port is empty and is not configured with any input/output pad.

5. The integrated circuit as claimed in claim 1, wherein the first input/output pad partially covers the electrostatic discharge component, or the second input/output pad partially covers the first input/output cell.

6. The integrated circuit as claimed in claim 1, wherein the electrostatic discharge component is arranged in at least one subarea in the subareas of the j^{th} row, the first input/output cell is arranged in the subarea SA_{(i,j+1)} and a subarea SA_{(i,j+2)} in the subareas, the second input/output cell is arranged in the subarea SA_{(i+1,j+1)} and a subarea SA_{(i+1,j+2)} in the subareas, and the integrated circuit further comprises:
a third input/output cell, arranged in a subarea SA_{(i+2,j+1)} and a subarea SA_{(i+2,j+2)} of the subareas; and
a third input/output pad, disposed on the third input/output cell, and electrically connected to the third input/output cell.

7. The integrated circuit as claimed in claim 6, wherein one of the first input/output cell, the second input/output cell and the third input/output cell is a power/ground input/output cell, and the electrostatic discharge component is electrically connected to the power/ground input/output cell.

8. The integrated circuit as claimed in claim 6, wherein one of the first input/output cell, the second input/output cell and the third input/output cell is a signal input/output cell, and the signal input/output cell is electrically connected to a signal pin of a core circuit of the integrated circuit.

9. The integrated circuit as claimed in claim 8, wherein the signal input output cell comprises:
an active region, configured to accommodate a circuit layout of the signal input/output cell; and
a plurality of input/output ports, arranged in the active region, and configured to transmit a same signal of a same input/output pin, wherein each of the input/output ports provides a corresponding predetermined area, and each predetermined area accommodates an input/output pad,
wherein the input/output ports make the signal input/output cell to form a plurality of different configurations, and in each configuration, the predetermined area corresponding to at least one input/output port is configured with the input/output pad, and the predetermined area corresponding to at least one other input/output port is empty and is not configured with any input/output pad.

10. The integrated circuit as claimed in claim 6, wherein the first input output pad partially covers the electrostatic discharge component and the first input/output cell, or the second input/output pad partially covers the first input/output cell, the second input/output cell and the third input/output cell.

11. The integrated circuit as claimed in claim 6, wherein the electrostatic discharge component is arranged in at least one subarea in the subareas of the j^{th} row, the first input/output cell is arranged in the subarea SA_{(i,j+1)}, the subarea SA_{(i,j+2)} and a subarea SA_{(i,j+3)} in the subareas, the second input/output cell is arranged in the subarea SA_{(i+1,j+1)}, the subarea SA_{(i+1,j+2)} and a subarea SA_{(i+1,j+3)} in the subareas, and the third input/output cell is arranged in the subarea SA_{(i+2,j+1)}, the subarea SA_{(i+2,j+2)} and a subarea SA_{(i+2,j+3)} in the subareas, and the integrated circuit further comprises:
a fourth input/output cell, arranged in subareas SA_{(i+3,j+1)}, SA_{(i+3,j+2)} and SA_{(i+3,j+3)} of the subareas; and
a fourth input/output pad, disposed on the fourth input/output cell, and electrically connected to the fourth input/output cell.

12. An implementation method of an integrated circuit, comprising:
dividing a unit area into a plurality of subareas, wherein a subarea of an i^{th} column and a j^{th} row in the subareas is defined as SA_{(i,j)}, and i and j are integers;
arranging a first input/output cell in a subarea SA_{(i,j+1)} of the subareas;
arranging a second input/output cell in a subarea SA_{(i+1,j+1)} of the subareas;
arranging an electrostatic discharge component in at lease one of the subareas of the j^{th} row;
arranging a first input/output pad on the first input/output cell, and electrically connecting the first input/output pad to the first input/output cell; and
arranging a second input/output pad on the second input/output cell, and electrically connecting the second input/output pad to the second input/output cell.

13. The implementation method of the integrated circuit as claimed in claim 12, wherein one of the first input/output cell and the second input/output cell is a power/ground input/output cell, and the electrostatic discharge component is electrically connected to the power/ground input/output cell.

14. The implementation method of the integrated circuit as claimed in claim 13, wherein the power/ground input/output cell has a metal layer and does not have any electronic component.

15. The implementation method of the integrated circuit as claimed in claim 12, wherein the first input/output pad partially covers the electrostatic discharge component, or the second input/output pad partially covers the first input/output cell.

16. The implementation method of the integrated circuit as claimed in claim 12, wherein the electrostatic discharge component is arranged in at least one subarea in the subareas of the j^{th} row, the first input/output cell is arranged in the subarea SA_{(i,j+1)} and a subarea SA_{(i,j+2)} in the subareas, the second input/output cell is arranged in the subarea SA_{(i+1,j+1)} and a subarea SA_{(i+1,j+2)} in the subareas, and implementation method of the integrated circuit further comprises:
arranging a third input/output cell in a subarea SA_{(i+2,j+1)} and a subarea SA_{(i+2,j+2)} of the subareas; and
arranging a third input/output pad on the third input/output cell, and electrically connecting the third input/output pad to the third input/output cell.

17. The implementation method of the integrated circuit as claimed in claim 16, wherein one of the first input/output cell, the second input/output cell and the third input/output cell is a power/ground input/output cell, and the electrostatic discharge component is electrically connected to the power/ground input/output cell.

18. The implementation method of the integrated circuit as claimed in claim 16, wherein one of the first input/output cell, the second input/output cell and the third input/output cell is a signal input/output cell, and the signal input/output cell is electrically connected to a signal pin of a core circuit of the integrated circuit.

19. The implementation method of the integrated circuit as claimed in claim 16, wherein the first input output pad partially covers the electrostatic discharge component and the first input/output cell, or the second input/output pad partially covers the first input/output cell, the second input/output cell and the third input/output cell.

20. The implementation method of the integrated circuit as claimed in claim 16, wherein the electrostatic discharge component is arranged in at least one subarea in the subareas of the j^{th} row, the first input/output cell is arranged in the subarea SA_{(i,j+1)}, the subarea SA_{(i,j+2)} and a subarea SA_{(i,j+3)} in the subareas, the second input/output cell is arranged in the subarea SA_{(i+1,j+1)}, the subarea SA_{(i+1,j+2)} and a subarea SA_{(i+1,j+3)} in the subareas, and the third input/output cell is arranged in the subarea SA_{(i+2,j+1)}, the subarea SA_{(i+2,j+2)} and a subarea SA_{(i+2,j+3)} in the subareas, and implementation method of the integrated circuit further comprises:
arranging a fourth input/output cell in subareas SA_{(i+3,j+1)}, SA_{(i+3,j+2)} and SA_{(i+3,j+3)} of the subareas; and
disposing a fourth input/output pad on the fourth input/output cell, and electrically connecting the fourth input/output pad to the fourth input/output cell.
